(19) United States
(12) Patent Application Publication
(10) Pub. No.: US 2025/0282620 A1
(43) Pub. Date: Sep. 11, 2025

(54) Porous Carbon/Anode Active Material Composite, Anode, Lithium-ion Battery, and Production Method

(71) Applicant: Honeycomb Battery Company, Dayton, OH (US)

(72) Inventors: Song-Hai Chai, Dayton, OH (US); Hao-Hsun Chang, Centerville, OH (US); Bor Z. Jang, Centerville, OH (US)

(73) Assignee: Honeycomb Battery Company, Dayton, OH (US)

(21) Appl. No.: 18/596,745

(22) Filed: Mar. 6, 2024

(51) Int. Cl. C01B 32/05; H01M 10/0525

(52) U.S. Cl. CPC C01B 32/05; H01M 10/0525; C01P 2004/61; C01P 2004/64; C01P 2006/14; C01P 2006/16

(57) ABSTRACT

A porous carbon/anode material composite, including: (a) a porous carbon structure host having pores and pore walls (e.g., carbon framework or skeletons); (b) a plurality of anode active material particles that are disposed in said pores and wherein a weight fraction of the anode active material particles in the composite is from 0.1% to 99%; and (c) an optional carbon coating deposited on a surface of the active material particles or a carbon matrix with the anode active material particles dispersed in the carbon matrix, wherein the carbon coating occupies from 0% to 30% by weight of the composite. Also provided is an anode, including such a porous carbon/anode material particle composite, a lithium-ion cell including such an anode, and a method of producing the porous composite.

### FIELD

This invention relates generally to an anode active material deposited in the pores of a porous carbon structure host, a method of producing such a porous carbon-hosted anode active material composition, an anode including such a composition, and a lithium-ion battery featuring such an anode.

### BACKGROUND

A unit cell or building block of a lithium-ion battery is typically composed of an anode current collector, an anode or negative electrode layer (containing an anode active material responsible for storing lithium therein, a conductive additive, and a resin binder), an electrolyte and/or separator, a cathode or positive electrode layer (containing a cathode active material responsible for storing lithium therein, a conductive additive, and a resin binder), and a separate cathode current collector. The electrolyte is in ionic contact with both the anode active material and the cathode active material. A porous separator is not required if the electrolyte is a solid-state electrolyte.

The binder in the binder layer is used to bond the anode active material (e.g. graphite or Si particles) and a conductive filler (e.g. carbon black or carbon nanotube) together to form an anode layer of structural integrity, and to bond the anode layer to a separate anode current collector, which acts to collect electrons from the anode active material when the battery is discharged. In other words, in the negative electrode (anode) side of the battery, there are typically four different materials involved: an anode active material, a conductive additive, a resin binder (e.g., polyvinylidine fluoride, PVDF, or styrene-butadiene rubber, SBR), and an anode current collector (typically a sheet of Cu foil). Typically the former three materials form a separate, discrete anode layer and the latter one forms another discrete layer.

The most commonly used anode active materials for lithium-ion batteries are natural graphite and synthetic graphite (or artificial graphite) that can be intercalated with lithium and the resulting graphite intercalation compound (GIC) may be expressed as LiₓC₆, where x is typically less than 1. The maximum amount of lithium that can be reversibly intercalated into the interstices between graphene planes of a perfect graphite crystal corresponds to x=1, defining a theoretical specific capacity of 372 mAh/g.

Graphite or carbon anodes can have a long cycle life due to the presence of a protective solid-electrolyte interface layer (SEI), which results from the reaction between lithium and the electrolyte (or between lithium and the anode surface/edge atoms or functional groups) during the first several charge-discharge cycles. The lithium in this reaction comes from some of the lithium ions originally intended for the charge transfer purpose. As the SEI is formed, the lithium ions become part of the inert SEI layer and become irreversible, i.e. these positive ions can no longer be shuttled back and forth between the anode and the cathode during charges/discharges. Therefore, it is desirable to use a minimum amount of lithium for the formation of an effective SEI layer. In addition to SEI formation, the irreversible capacity loss Qᵢᵣ can also be attributed to graphite exfoliation caused by electrolyte/solvent co-intercalation and other side reactions.

In addition to carbon-or graphite-based anode materials, other inorganic materials that have been evaluated for potential anode applications include metal oxides, metal nitrides, metal sulfides, and the like, and a range of metals, metal alloys, and intermetallic compounds that can accommodate lithium atoms/ions or react with lithium. Among these materials, lithium alloys having a composition formula of LiₐA (A is a metal or semiconductor element, such as Al and Si, and “a” satisfies 0<a≤5) are of great interest due to their high theoretical capacity, e.g., Li₄Si (3,829 mAh/g), Li_{4.4}Si (4,200 mAh/g), Li_{4.4}Ge (1,623 mAh/g), Li_{4.4}Sn (993 mAh/g), Li₃Cd (715 mAh/g), Li₃Sb (660 mAh/g), Li_{4.4}Pb (569 mAh/g), LiZn (410 mAh/g), and Li₃Bi (385 mAh/g). However, as schematically illustrated in FIG. 2(A), in an anode composed of these high-capacity materials, severe pulverization (fragmentation of the alloy particles) occurs during the charge and discharge cycles due to severe expansion and contraction of the anode active material particles induced by the insertion and extraction of the lithium ions in and out of these particles. The expansion and contraction, and the resulting pulverization, of active material particles, lead to loss of contacts between active material particles and conductive additives and loss of contacts between the anode active material and its current collector. These adverse effects result in a significantly shortened charge-discharge cycle life.

To overcome the problems associated with such mechanical degradation, three technical approaches have been proposed:
(1) reducing the size of the active material particle, presumably for the purpose of reducing the total strain energy that can be stored in a particle, which is a driving force for crack formation in the particle. However, a reduced particle size implies a higher surface area available for potentially reacting with the liquid electrolyte to form a higher amount of SEI. Such a reaction is undesirable since it is a source of irreversible capacity loss.
(2) depositing the electrode active material in a thin film form directly onto a current collector, such as a copper foil. However, such a thin film structure with an extremely small thickness-direction dimension (typically much smaller than 500 nm, often necessarily thinner than 100 nm) implies that only a small amount of active material can be incorporated in an electrode (given the same electrode or current collector surface area), providing a low total lithium storage capacity and low lithium storage capacity per unit electrode surface area (even though the capacity per unit mass can be large). Such a thin film should have a thickness less than 100 nm to be more resistant to cycling-induced cracking, further diminishing the total lithium storage capacity and the lithium storage capacity per unit electrode surface area. Such a thin-film battery has very limited scope of application. A desirable and typical electrode thickness is from 100 μm to 200 μm. These thin-film electrodes (with a thickness of <500 nm or even <100 nm) fall short of the required thickness by three (3) orders of magnitude, not just by a factor of 3.
(3) using a composite composed of small electrode active particles protected by (dispersed in or encapsulated by) a less active or non-active matrix, e.g., carbon-coated Si particles, sol gel graphite-protected Si, metal oxide-coated Si or Sn, and monomer-coated Sn nano particles. Presumably, the protective matrix provides a cushioning effect for particle expansion or shrinkage, and prevents the electrolyte from contacting and reacting with the electrode active material. Examples of high-capacity anode active particles are Si, Sn, and SnO₂. Unfortunately, when an active material particle, such as Si particle, expands (e.g., up to a volume expansion of 380%) during the battery charge step, the protective coating is easily broken due to the mechanical weakness and/o brittleness of the protective coating materials. There has been no high-strength and high-toughness material available that is itself also lithium ion conductive.

It may be further noted that the coating or matrix materials used to protect active particles (such as Si and Sn) are carbon, sol gel graphite, metal oxide, monomer, ceramic, and lithium oxide. These protective materials are all very brittle, weak (of low strength), and/or non-conducting (e.g., ceramic or oxide coating). Ideally, the protective material should meet the following requirements: (a) The coating or matrix material should be of high strength and stiffness so that it can help to refrain the electrode active material particles, when lithiated, from expanding to an excessive extent. (b) The protective material should also have high fracture toughness or high resistance to crack formation to avoid disintegration during repeated cycling. (c) The protective material should be inert (inactive) with respect to the electrolyte, but be a good lithium ion conductor. (d) The protective material should not provide any significant amount of defect sites that irreversibly trap lithium ions. (e) The protective material should be lithium ion-conducting as well as electron-conducting. The prior art protective materials all fall short of these requirements. Hence, it was not surprising to observe that the resulting anode typically shows a reversible specific capacity much lower than expected. In many cases, the first-cycle efficiency is extremely low (mostly lower than 80% and some even lower than 60%). Furthermore, in most cases, the electrode was not capable of operating for a large number of cycles. Additionally, most of these electrodes are not high-rate capable, exhibiting unacceptably low capacity at a high discharge rate.

Due to these and other reasons, most of prior art composite electrodes and electrode active materials have deficiencies in some ways, e.g., in most cases, less than satisfactory reversible capacity, poor cycling stability, high irreversible capacity, ineffectiveness in reducing the internal stress or strain during the lithium ion insertion and extraction steps, and other undesirable side effects.

Complex composite particles of particular interest are a mixture of separate Si and graphite particles dispersed in a carbon matrix; e.g., those prepared by Mao, et al. [“Carbon-coated Silicon Particle Powder as the Anode Material for Lithium Batteries and the Method of Making the Same,” US 2005/0136330 (Jun. 23, 2005)]. Also of interest are carbon matrix-containing complex nano Si (protected by oxide) and graphite particles dispersed therein, and carbon-coated Si particles distributed on a surface of graphite particles Again, these complex composite particles led to a low specific capacity or for up to a small number of cycles only. It appears that carbon by itself is relatively weak and brittle and the presence of micron-sized graphite particles does not improve the mechanical integrity of carbon since graphite particles are themselves relatively weak. Graphite was used in these cases presumably for the purpose of improving the electrical conductivity of the anode material. Furthermore, certain carbon materials may have too many lithium-trapping sites that irreversibly capture lithium during the first few cycles, resulting in excessive irreversibility.

In summary, the prior art has not demonstrated a composite material that has all or most of the properties desired for use as an anode active material in a lithium-ion battery. Thus, there is an urgent and continuing need for a new anode active material that enables a lithium-ion battery to exhibit a high cycle life, high reversible capacity, low irreversible capacity, small particle sizes (for high-rate capacity), and compatibility with commonly used electrolytes. There is also a need for a method of readily or easily producing such a material in large quantities.

Thus, it is an object of the present invention to meet these needs and address the issues associated the rapid capacity decay of a lithium battery containing a high-capacity anode active material.

### SUMMARY

The aforementioned issues can be resolved by the presently disclosed porous carbon/anode material composite and its production method. In certain embodiments, the disclosure provides a porous carbon/anode material composite, including: (a) a porous carbon structure host having pores and pore walls (e.g., carbon framework or skeletons); (b) a plurality of anode active material particles that are disposed in the pores or bonded to the pore walls, wherein a weight fraction of the anode active material particles in the composite is from 0.1% to 99%; and (c) an optional carbon coating deposited on a surface of the anode active material particles or a carbon matrix with the active material particles dispersed in the carbon matrix, wherein the carbon coating or matrix occupies from 0% to 80% by weight (preferably 1% to 60%, more preferably less than 50%, further preferably less than 30%) of the composite.

In the porous composite, the anode active material may be selected from the group consisting of: (a) silicon (Si), germanium (Ge), tin (Sn), lead (Pb), antimony (Sb), phosphorus (P), bismuth (Bi), zinc (Zn), aluminum (Al), titanium (Ti), nickel (Ni), cobalt (Co), and cadmium (Cd); (b) alloys or intermetallic compounds of Si, Ge, Sn, Pb, Sb, Bi, Zn, Al, Ti, Ni, Co, or Cd with other elements; (c) oxides, carbides, nitrides, sulfides, phosphides, selenides, and tellurides of Si, Ge, Sn, Pb, Sb, Bi, Zn, Al, Ti, Fe, Ni, Co, V, or Cd, and their mixtures, composites, or lithium-containing composites; (d) salts and hydroxides of Sn; (e) lithium titanate, lithium manganate, lithium aluminate, lithium titanium niobium oxide, lithium-containing titanium oxide, lithium transition metal oxide, ZnCo₂O₄; (f) carbon or graphite particles; (g) prelithiated versions thereof; and (h) combinations thereof.

In certain preferred embodiments, the porous composite is in a particulate form having a particle size (e.g., diameter or thickness) from 50 nm to 50 μm.

The pores preferably have a pore size from 5 nm to 10 μm (more preferably from 50 nm to 5 μm) and the porous carbon structure host has a porosity level from 0.5% to 99% (more preferably from 5% to 98% and further preferably from 20% to 95%) prior to hosting the anode active material particles. In some preferred embodiments, one or a plurality of anode active material particles, having a total volume Va, resides in a pore having a pore volume Vp and the Vp/Va ratio is from 1.2 to 5.0, preferably from 1.5 to 4.0. This would provide adequate space to accommodate volume expansion of the anode active material particles when the lithium-ion cell is charged.

Preferably, in the porous composite, the pores are interconnected and the porous carbon structure host has a porosity level from 50% to 90%.

In some embodiments, the anode active material particles are deposited with a carbon coating and these active material particles are bonded to the pore walls of the carbon structure through the carbon coating.

In certain embodiments, the porous carbon structure host includes a material selected from carbon foam, graphite foam, graphene foam, carbon aerogel, graphite aerogel, graphene aerogel, activated carbon, porous soft carbon, porous hard carbon, porous graphite particle, porous graphene particle or graphene ball, porous meso-carbon micro-bead (MCMB), porous coke particle, a porous structure of pyrolyzed polymer or polymeric carbon, or a combination thereof.

In certain preferred embodiments, the porous carbon structure host includes a material selected from carbon foam or carbon aerogel, wherein the carbon foam or carbon aerogel is reinforced with graphene sheets, carbon nanotubes, carbon or graphite fibers, ceramic fibers, glass fibers, polymer fibers, or a combination thereof.

The porous composite may be in a particle form and the composite particle is further encapsulated by or coated with a layer of carbon, graphene, an ion-conducting polymer having a lithium ion conductivity no less than 10⁻⁶ S/cm, an electron-conducting polymer having an electric conductivity no less than 10⁻⁶ S/cm, or a combination thereof.

The ion-conducting polymer is preferably selected from poly(ethylene oxide), polypropylene oxide, polyoxymethylene, polyvinylene carbonate, polypropylene carbonate, poly(ethylene glycol), poly(acrylonitrile), poly(methyl methacrylate), poly(vinylidene fluoride), poly bis-methoxy ethoxyethoxide-phosphazenex, polyvinyl chloride, polydimethylsiloxane, poly(vinylidene fluoride)-hexafluoropropylene, cyanoethyl poly(vinyl alcohol), a pentaerythritol tetraacrylate-based polymer, an aliphatic polycarbonate, a single Li-ion conducting solid polymer with a carboxylate anion, a sulfonylimide anion, or sulfonate anion, poly(ethylene glycol) diacrylate, poly(ethylene glycol) methyl ether acrylate, polyurethane, polyurethan-urea, polyacrylamide, a polyionic liquid, polymerized 1,3-dioxolane, polyepoxide ether, polysiloxane, poly(acrylonitrile-butadiene), polynorbornene, poly(hydroxyl styrene), poly(ether ether ketone), polypeptoid, poly(ethylene-maleic anhydride), polycaprolactone, poly(trimethylene carbonate), a copolymer thereof, a sulfonated derivative thereof, or a combination thereof.

The electron-conducting polymer preferably includes a conjugated polymer selected from polyacetylene, polythiophene, poly(3-alkylthiophenes), polypyrrole, polyaniline, poly(isothianaphthene), poly(3,4-ethylenedioxythiophene), alkoxy-substituted poly(p-phenylene vinylene), poly(2,5-bis(cholestanoxy)phenylene vinylene), poly(p-phenylene vinylene), poly(2,5-dialkoxy)paraphenylene vinylene, poly[(1,4-phenylene-1,2-diphenylvinylene)], poly(3′,7′-dimethyloctyloxy phenylene vinylene), polyparaphenylene, polyparaphenylene, polyparaphenylene sulphide, polyheptadiyne, poly(3-hexylthiophene), poly(3-octylthiophene), poly(3-cyclohexylthiophene), poly(3-methyl-4-cyclohexylthiophene), poly(2,5-dialkoxy-1,4-phenyleneethynylene), poly(2-decyloxy-1,4-phenylene), poly(9,9-dioctylfluorene), polyquinoline, a derivative thereof, a copolymer thereof, a sulfonated version thereof, or a combination thereof.

The disclosure also provides an anode (negative electrode) for a lithium battery, wherein the anode includes the disclosed porous composite as an anode material, an optional binder, and an optional conductive additive. The disclosure further discloses a lithium battery, wherein the lithium battery includes an anode containing the disclosed porous composite, a cathode, a separator between the anode and the cathode, and an electrolyte in ionic contact with the anode and the cathode. The separator can contain the electrolyte or can simply be the electrolyte if the electrolyte is a solid-state electrolyte (polymeric, inorganic, or composite solid electrolyte).

The present disclosure also provides a method of producing the presently disclosed porous carbon/anode active material composite, the method including: (A) preparing a porous polymer structure including particles of an anode active material dispersed therein; (B) thermally converting the polymer structure to a carbon structure host having pores and pore walls to host or support the anode active material particles to form a porous carbon/anode material composite structure; and (C) optionally, mechanically breaking down the porous composite structure into a plurality of porous carbon/anode material composite particles having a dimension (e.g., diameter or thickness) from 50 nm to 50 μm. The procedure of mechanical breaking includes a procedure selected from grinding, mechanical milling, air jet milling, or ball-milling.

The anode active material particles in step (A) may be pre-coated with a carbon precursor coating or dispersed in a carbon precursor matrix, and step (B) includes thermally converting both the carbon precursor (coating or matrix) and the polymer structure into an integrated porous carbon structure, wherein the carbon material converted from the carbon precursor and the carbon material converted from the polymer structure are merged into a contiguous or continuous carbon phase. The carbon precursor is preferably selected from a polymer, an organic material, pitch (e.g., petroleum pitch, coal tar pitch, bio-pitch, etc.), petroleum heavy oil, bio-fuel or oil, sugar or glucose, or a combination thereof.

Step (A) may include at least a procedure selected from (i) preparing multiple polymer fibers and mixing a plurality of anode active material particles to form a nonwoven structure having pores or interstitial spaces between fibers and the anode active material particles reside in the pores or interstitial spaces; (ii) preparing a polymer foam structure having pores and pore walls and having a plurality of anode active material particles residing in the pores or bonded to said pore walls, and (iii) impregnating a carbon precursor matrix or coating into pores of the porous carbon host containing anode active material particles therein, wherein the anode active material particles are coated with or dispersed in the carbon precursor.

The disclosure further provides a method of producing porous carbon/anode material composite as herein disclosed, the method including: (a) preparing a porous carbon structure including particles of an anode active material dispersed therein, wherein (i) the porous carbon structure host includes a material selected from carbon foam, graphite foam, graphene foam, carbon aerogel, graphite aerogel, graphene aerogel, activated carbon, porous soft carbon, porous hard carbon, porous graphite particle, porous graphene particle or graphene ball, porous meso-carbon micro-bead (MCMB), porous coke particle, a porous structure of pyrolyzed polymer or polymeric carbon, or a combination thereof, and (ii) the anode material particles are coated with a carbon precursor or dispersed in a carbon precursor; and (b) thermally converting the carbon precursor into carbon, wherein the carbon converted from the carbon precursor and the porous carbon structure prepared in step (a) are merged into a contiguous or continuous carbon phase, enabling the anode material particles to strongly bond to the carbon phase. The carbon precursor is preferably selected from a polymer, an organic material, pitch (e.g., petroleum pitch, coal tar pitch, bio-pitch, etc.), petroleum heavy oil, bio-fuel or oil, sugar or glucose, or a combination thereof. Preferably, the porous composite is mechanically broken down into porous composite particles having a particle size preferably from 50 nm to 50 μm.

The disclosed method may further include a step of prelithiating the plurality of porous carbon/prelithiated anode active material composite particles.

The method may further include a step of encapsulating or coating the multiple composite particles of porous carbon/silicon oxide with a layer of carbon, graphene, an ion-conducting polymer having a lithium ion conductivity no less than 10⁻⁶ S/cm, an electron-conducting polymer having an electric conductivity no less than 10⁻⁶ S/cm, or a combination thereof.

The method may further include a step of encapsulating or coating the porous composite particles with a layer of carbon, graphene, an ion-conducting polymer having a lithium ion conductivity no less than 10⁻⁶ S/cm, an electron-conducting polymer having an electric conductivity no less than 10⁻⁶ S/cm, or a combination thereof.

The disclosure provides a method of producing porous carbon/anode material composite structure as herein disclosed, wherein the method includes a procedure of dispersing a plurality of particles of an anode active material into pores of a porous polymer fiber nonwoven or polymer foam structure and thermally converting the porous polymer fiber nonwoven or polymer foam into a porous carbon structure. This method does not involve chemical vapor deposition of an anode material (e.g., Si) via infiltrating silane gas molecules into pores of a pre-made carbon host structure and thermally decomposing silane into Si in the pores. Silane gas is toxic, explosive, and expensive.

### BRIEF DESCRIPTION OF THE DRAWINGS

FIG. 1(A) Schematic of a porous composite structure including particles of an anode active material hosted by a porous carbon structure according to some embodiments of the instant disclosure;

FIG. 1(B) Schematic of a porous composite particulate including particles of an anode active material hosted by a porous carbon particle according to some embodiments of the instant disclosure; multiple porous composite particulates may be produced by mechanically breaking a porous composite structure described in FIG. 1(A).

FIG. 2(A) Schematic of a process for producing the porous carbon composite structure, including a procedure of forming polymer-encapsulated Si particles (single or multiple Si particles encapsulated by or dispersed in a polymer), followed by procedures of mixing these polymer-encapsulated Si particles with a polymer foam precursor, polymer foaming, and carbonization;

FIG. 2(B) Schematic of a lithium-ion cell including an anode that contains anode active material particles residing in pores or bonded to pore walls of a porous carbon host according to certain embodiments of the present disclosure;

FIG. 2(C) Schematic of a lithium-ion cell including an anode that includes a plurality of porous carbon composite particulates, wherein a porous composite particulate contains anode active material particles residing in pores or bonded to pore walls of a porous carbon host particle according to certain embodiments of the present disclosure.

FIG. 3(A) A process flow chart showing preferred routes to prepare a porous carbon composite structure, including anode active material particles residing in pores of a porous carbon host, from a polymer fiber-based nonwoven structure according to some preferred embodiments of the present disclosure;

FIG. 3(B) Another process flow chart showing preferred routes to prepare a porous carbon composite structure from a polymer foam structure, wherein the porous carbon composite includes anode active material particles residing in pores of a porous carbon foam host according to some preferred embodiments of the present disclosure.

### DETAILED DESCRIPTION

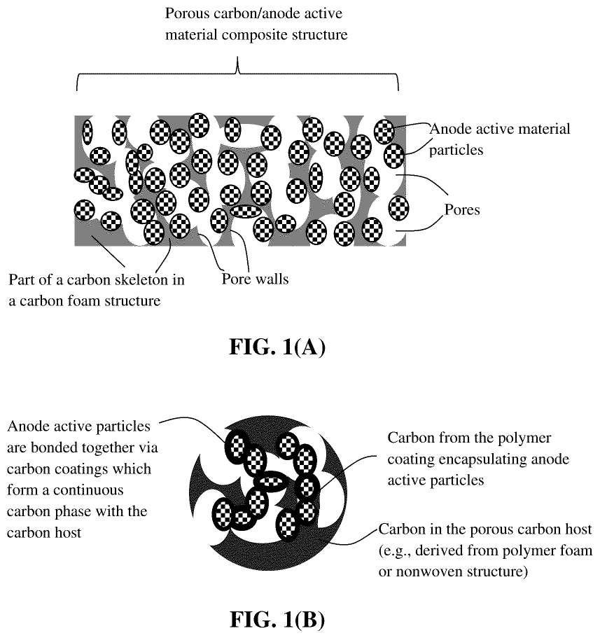

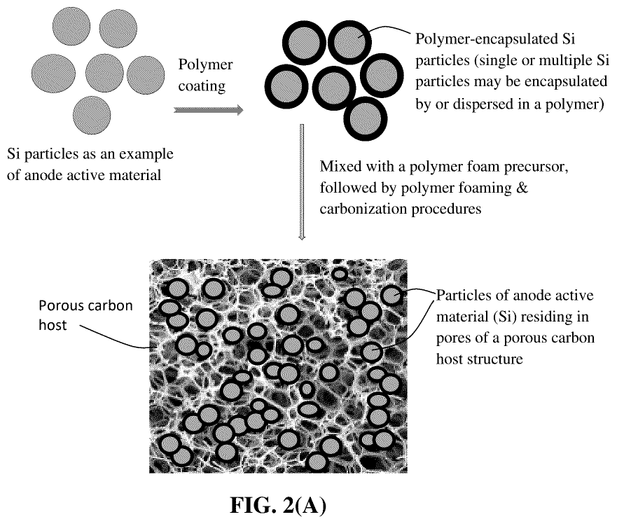

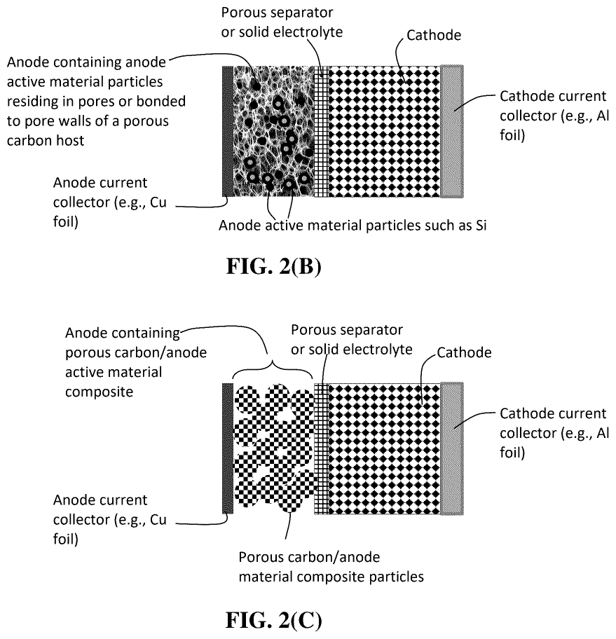

The present disclosure provides a porous carbon/anode material composite (as schematically illustrated in FIG. 1(A)), including: (a) a porous carbon structure host having pores and pore walls (e.g., carbon framework or skeletons); (b) a plurality of anode active material particles that are disposed in the pores or bonded to the pore walls, wherein a weight fraction of the anode active material particles in the composite is from 0.1% to 99%; and (c) an optional carbon coating deposited on surfaces of the active material particles (as schematically illustrated in FIG. 2(A)), wherein the carbon coating occupies from 0% to 80% by weight (preferably 1% to 60%, more preferably less than 50%, further preferably less than 30%) of the composite.

In the porous composite, the anode active material may be selected from the group consisting of: (a) silicon (Si), germanium (Ge), tin (Sn), lead (Pb), antimony (Sb), phosphorus (P), bismuth (Bi), zinc (Zn), aluminum (Al), titanium (Ti), nickel (Ni), cobalt (Co), and cadmium (Cd); (b) alloys or intermetallic compounds of Si, Ge, Sn, Pb, Sb, Bi, Zn, Al, Ti, Ni, Co, or Cd with other elements; (c) oxides, carbides, nitrides, sulfides, phosphides, selenides, and tellurides of Si, Ge, Sn, Pb, Sb, Bi, Zn, Al, Ti, Fe, Ni, Co, V, or Cd, and their mixtures, composites, or lithium-containing composites; (d) salts and hydroxides of Sn; (e) lithium titanate, lithium manganate, lithium aluminate, lithium titanium niobium oxide, lithium-containing titanium oxide, lithium transition metal oxide, ZnCo₂O₄; (f) carbon or graphite particles; (g) prelithiated versions thereof; and (h) combinations thereof.

In certain preferred embodiments, as schematically illustrated in FIG. 1(B), the porous composite is in a particulate form having a particle size (e.g., diameter or thickness) from 50 nm to 50 μm.

The pores preferably have a pore size from 5 nm to 10 μm (more preferably from 50 nm to 5 μm) and the porous carbon structure host has a porosity level from 0.5% to 99% (more preferably from 5% to 98% and further preferably from 20% to 95%) prior to hosting the anode active material particles. In some preferred embodiments, one or a plurality of anode active material particles, having a total volume Va, resides in a pore having a pore volume Vp and the Vp/Va ratio is from 1.2 to 5.0, preferably from 1.5 to 4.0. This would provide adequate space to accommodate volume expansion of the anode active material particles when the lithium-ion cell is charged.

In some preferred embodiments, the pores in the porous composite are interconnected and the porous carbon structure host has a porosity level from 50% to 90%.

In some embodiments, the anode active material particles are deposited with a carbon coating (or dispersed in a matrix of carbon) and these active material particles are bonded to the pore walls of the carbon structure through the carbon coating or carbon matrix.

In certain embodiments, the porous carbon structure host includes a material selected from carbon foam, graphite foam, graphene foam, carbon aerogel, graphite aerogel, graphene aerogel, activated carbon, porous soft carbon, porous hard carbon, porous graphite particle, porous graphene particle or graphene ball, porous meso-carbon micro-bead (MCMB), porous coke particle, a porous structure of pyrolyzed polymer or polymeric carbon, or a combination thereof.

In certain preferred embodiments, the porous carbon structure host includes a material selected from carbon foam or carbon aerogel, wherein the carbon foam or carbon aerogel is reinforced with graphene sheets, carbon nanotubes, carbon or graphite fibers, ceramic fibers, glass fibers, polymer fibers, or a combination thereof to improve the mechanical strength and integrity of the carbon foam or carbon aerogel.

The porous composite may be in a particle form and the composite particle is further encapsulated by or coated with a layer of carbon, graphene, an ion-conducting polymer having a lithium ion conductivity no less than 10⁻⁶ S/cm, an electron-conducting polymer having an electric conductivity no less than 10⁻⁶ S/cm, or a combination thereof.

The ion-conducting polymer is preferably selected from poly(ethylene oxide), polypropylene oxide, polyoxymethylene, polyvinylene carbonate, polypropylene carbonate, poly(ethylene glycol), poly(acrylonitrile), poly(methyl methacrylate), poly(vinylidene fluoride), poly bis-methoxy ethoxyethoxide-phosphazenex, polyvinyl chloride, polydimethylsiloxane, poly(vinylidene fluoride)-hexafluoropropylene, cyanoethyl poly(vinyl alcohol), a pentaerythritol tetraacrylate-based polymer, an aliphatic polycarbonate, a single Li-ion conducting solid polymer with a carboxylate anion, a sulfonylimide anion, or sulfonate anion, poly(ethylene glycol) diacrylate, poly(ethylene glycol) methyl ether acrylate, polyurethane, polyurethan-urea, polyacrylamide, a polyionic liquid, polymerized 1,3-dioxolane, polyepoxide ether, polysiloxane, poly(acrylonitrile-butadiene), polynorbornene, poly(hydroxyl styrene), poly(ether ether ketone), polypeptoid, poly(ethylene-maleic anhydride), polycaprolactone, poly(trimethylene carbonate), a copolymer thereof, a sulfonated derivative thereof, or a combination thereof.

The electron-conducting polymer preferably includes a conjugated polymer selected from polyacetylene, polythiophene, poly(3-alkylthiophenes), polypyrrole, polyaniline, poly(isothianaphthene), poly(3,4-ethylenedioxythiophene), alkoxy-substituted poly(p-phenylene vinylene), poly(2,5-bis(cholestanoxy)phenylene vinylene), poly(p-phenylene vinylene), poly(2,5-dialkoxy)paraphenylene vinylene, poly[(1,4-phenylene-1,2-diphenylvinylene)], poly(3′,7′-dimethyloctyloxy phenylene vinylene), polyparaphenylene, polyparaphenylene, polyparaphenylene sulphide, polyheptadiyne, poly(3-hexylthiophene), poly(3-octylthiophene), poly(3-cyclohexylthiophene), poly(3-methyl-4-cyclohexylthiophene), poly(2,5-dialkoxy-1,4-phenyleneethynylene), poly(2-decyloxy-1,4-phenylene), poly(9,9-dioctylfluorene), polyquinoline, a derivative thereof, a copolymer thereof, a sulfonated version thereof, or a combination thereof.

The disclosure also provides an anode (negative electrode) for a lithium battery, wherein the anode includes the disclosed porous composite as an anode material, an optional binder, and an optional conductive additive. The disclosure further provides a lithium-ion battery (as schematically illustrated in FIG. 2(B) and FIG. 2(C)), wherein the lithium battery includes an anode containing the disclosed porous composite, a cathode, a separator between the anode and the cathode, and an electrolyte in ionic contact with the anode and the cathode.

In FIG. 2(B), the anode includes a porous carbon/anode material composite and no binder or conductive additive is required. In FIG. 2(C), the anode includes multiple porous carbon/anode material composite particulates, each including a porous carbon host and anode active material particles residing in the pores or bonded to the pore walls of the composite particles. These composite particles are preferably bonded by a resin binder (not shown), but additional conductive additive is optional and not required. The separator can contain the electrolyte or can simply be the electrolyte if the electrolyte is a solid-state electrolyte (polymeric, inorganic, or composite solid electrolyte).

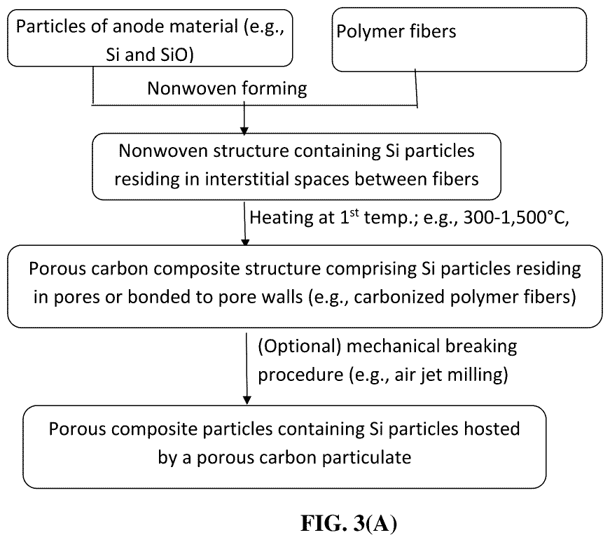

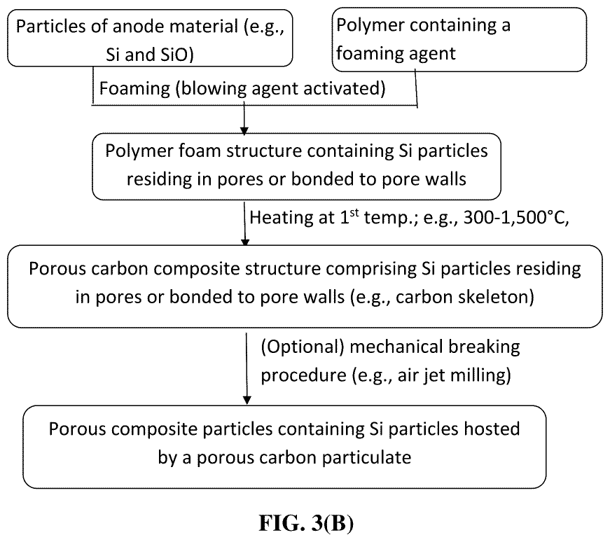

As illustrated in FIG. 3(A) and FIG. 3(B), the present disclosure also provides a method of producing the presently disclosed porous carbon/anode active material composite. In certain embodiments, the method includes: (A) preparing a porous polymer structure (e.g., polymer foam, nonwoven fabric, etc.) including particles of an anode active material dispersed therein; (B) thermally converting the polymer structure to a carbon structure host having pores and pore walls to host or support the anode active material particles to form a porous carbon/anode material composite structure; and (C) optionally, mechanically breaking down the porous composite structure into a plurality of porous carbon/anode material composite particles having a dimension from 50 nm to 50 μm. The procedure of mechanical breaking includes a procedure selected from grinding, mechanical milling, air jet milling, or ball-milling.

The anode active material particles in step (A) may be pre-coated with a carbon precursor and step (B) includes thermally converting both the carbon precursor and the polymer structure into an integrated porous carbon structure, wherein the carbon material converted from the carbon precursor and the carbon material converted from the polymer structure are merged into a contiguous or continuous carbon phase, as schematically illustrated in FIG. 1(B). The carbon precursor is preferably selected from a polymer, an organic material, pitch (e.g., petroleum pitch, coal tar pitch, bio-pitch, etc.), petroleum heavy oil, bio-fuel or oil, sugar or glucose, or a combination thereof.

The anode active material particles may be dispersed in a carbon matrix or coated with a carbon coating prior to being incorporated into the porous polymer structure (e.g., polymer fiber nonwoven or polymer foam) or porous carbon structure. Alternatively, the anode active material particles may be dispersed in a carbon precursor matrix or coated with a carbon precursor coating prior to being incorporated into the porous carbon structure. This precursor is then carbonized to form a carbon component which typically is capable of bonding to the porous carbon structure.

Further alternatively and preferably, the anode active material particles may be dispersed in a carbon precursor matrix or coated with a carbon precursor coating prior to being incorporated (e.g., impregnated) into the porous polymer structure (e.g., polymer fiber nonwoven or polymer foam) or porous carbon structure. This carbon precursor and the porous polymer structure are then carbonized concurrently to obtain a carbon phase, wherein the carbon component from the polymer matrix or coating is typically bonded well with the carbon from the porous polymer structure to form a continuous, integrated carbon structure or skeleton.

Step (A) may include at least a procedure selected from (i) preparing multiple polymer fibers and mixing a plurality of anode active material particles to form a nonwoven structure having pores or interstitial spaces between fibers and said anode active material particles reside in said pores or interstitial spaces; (ii) preparing a polymer foam structure having pores and pore walls and having a plurality of anode active material particles residing in said pores or bonded to said pore walls; and (iii) impregnating a carbon precursor matrix or coating into pores of the porous carbon host containing anode active material particles therein, wherein the anode active material particles are coated with or dispersed in the carbon precursor.

Nonwoven fabric is a fabric-like material made from staple fibers (short) or long fibers (continuous long), bonded together by chemical, mechanical, heat or solvent treatment. The term is used in the textile manufacturing industry to denote fabrics, such as felt, which are neither woven nor knitted. Nonwoven fabrics may be produced from polymers such as polypropylene (PP), polyethylene (PE), polyethylene terephthalate (PET), rayon, wood pulp, polyamide, polycarbonate, polyacrylonitrile (PAN), polyamide (PA), polyester, natural fibers, and biopolymer fibers. The processes include staple nonwoven procedures, melt-blown, spunlace, spunbond, wet laid, dry laid, air laid, electrostatic spinning, and flash-spun. They can be single-layer or multilayer structures. These processes are well-known in the art. The particles of an anode active material may be mixed with the polymer fibers before (preferred), during, or after the nonwoven fabric is made.

A polymeric foam is a solid open-cell or closed-cell structure containing pores and polymer walls. Examples of polymer foam include: (a) Ethylene-vinyl acetate (EVA) foam, the copolymers of ethylene and vinyl acetate; also referred to as polyethylene-vinyl acetate (PEVA); (b) Low-density polyethylene (LDPE) foam, first grade of polyethylene (PE); (c) Nitrile rubber (NBR) foam, the copolymers of acrylonitrile (ACN) and butadiene; (d) Polychloroprene foam or Neoprene; (e) Polyimide foam; (f) Polypropylene (PP) foam, including expanded polypropylene (EPP) and polypropylene paper (PPP); (g) Polystyrene (PS) foam, including expanded polystyrene (EPS), extruded polystyrene foam (XPS) and sometimes polystyrene paper (PSP); (g) Styrofoam, including extruded polystyrene foam (XPS) and sometimes expanded polystyrene (EPS); (i) Polyurethane (PU) foam, such as LRPu low-resilience polyurethane, Memory foam, and Sorbothane; (j) Polyurea foam; (k) Polyethylene foam, as used in PEF rod; (l) Polyvinyl chloride (PVC) foam, such as Closed-cell PVC foam board; (m) Silicone foam; and (n) Microcellular foam. The particles of anode active material may be mixed with the polymer (along with a foaming or blowing agent) before (preferred) or after the polymer foam is made.

The disclosure further provides a method of producing porous carbon/anode material composite as herein disclosed, the method including: (a) preparing a porous carbon structure including particles of an anode active material dispersed therein, wherein (i) the porous carbon structure host includes a material selected from carbon foam, graphite foam, graphene foam, carbon aerogel, graphite aerogel, graphene aerogel, activated carbon, porous soft carbon, porous hard carbon, porous graphite particle, porous graphene particle or graphene ball, porous meso-carbon micro-bead (MCMB), porous coke particle, a porous structure of pyrolyzed polymer or polymeric carbon, or a combination thereof, and (ii) the anode material particles are coated with a carbon precursor or dispersed in a carbon precursor; and (b) thermally converting the carbon precursor into carbon, wherein the carbon converted from the carbon precursor and the porous carbon structure prepared in step (a) are merged into a contiguous or continuous carbon phase, enabling the anode material particles to strongly bond to the carbon phase. The carbon precursor is preferably selected from a polymer, an organic material, pitch (e.g., petroleum pitch, coal tar pitch, bio-pitch, etc.), petroleum heavy oil, bio-fuel or oil, sugar or glucose, or a combination thereof. Preferably, the porous composite is mechanically broken down into porous composite particles having a particle size preferably from 50 nm to 50 μm.

The porous carbon structure host may be selected from carbon foam, graphite foam, graphene foam, carbon aerogel, graphite aerogel, graphene aerogel, activated carbon, porous soft carbon, porous hard carbon, porous graphite particle, porous graphene particle or graphene ball, porous meso-carbon micro-bead (MCMB), porous coke particle, a porous structure of pyrolyzed polymer or polymeric carbon, or a combination thereof. These porous carbon structures can be produced with known methods. The anode active material particles may be added into these porous structures before or after these structures are prepared.

For instance, graphene foam-anode particle composite may be produced by mixing and dispersing anode material particles (e.g., Si or SiOx particles), graphene oxide sheets, and an optional polymer (as a carbon precursor) in water or organic solvent to form a suspension. The resulting suspension or slurry is then cast on a surface of a solid substrate such as a glass and metal sheet. By removing the liquid medium from the cast layer one obtains a layer of mixed graphene sheets and anode particles (bonded by a polymer, if present). When exposed to a temperature of 200-1,500° C., the mixture is turned into a porous composite structure including anode particles residing in pores or bonded to the pore walls of the resulting graphene foam. The polymer, if present, helps to hold the graphene sheets and anode particles together. This polymer may be converted to carbon when the temperature exceeds 350° C.

The disclosed method may further include a step of prelithiating the plurality of porous carbon/prelithiated anode active material composite particles.

The method may further include a step of encapsulating or coating the multiple composite particles of porous carbon/silicon oxide with a layer of carbon, graphene, an ion-conducting polymer having a lithium ion conductivity no less than 10⁻⁶ S/cm, an electron-conducting polymer having an electric conductivity no less than 10⁻⁶ S/cm, or a combination thereof.

The disclosure provides a method of producing porous carbon/anode material composite structure as herein disclosed, wherein the method includes a procedure of dispersing a plurality of particles of an anode active material into pores of a porous polymer fiber nonwoven or polymer foam structure and thermally converting the porous polymer fiber nonwoven or polymer foam into a porous carbon structure. This method does not involve chemical vapor deposition of an anode material (e.g., Si) via infiltrating silane gas molecules into pores of a pre-made carbon host structure and thermally decomposing silane into Si in the pores. Silane gas is toxic, explosive, and expensive.

The method may further include a step of coating or encapsulating one or a plurality of composite particles of porous carbon host/anode material with a thin layer of graphene having a thickness from 0.34 nm to 100 nm. This can be accomplished by dispersing the porous composite particles and graphene sheets in a liquid medium to form a slurry, which is then spray-dried to form secondary particles containing composite particles encapsulated by graphene sheets. The graphene material involved in this method may be selected from pristine graphene, graphene oxide (GO), reduced graphene oxide (RGO), graphene fluoride (GF), graphene bromide (GB), graphene iodide (GI), boron-doped graphene, nitrogen-doped graphene, chemically functionalized graphene, or a combination thereof. The graphene material may include a single-layer or few-layer sheet of pristine graphene, graphene oxide, reduced graphene oxide, graphene fluoride, graphene chloride, graphene bromide, graphene iodide, boron-doped graphene, nitrogen-doped graphene, chemically functionalized graphene, or a combination thereof, wherein few layer is defined as less than 10 layers that are stacked together through van der Waals forces with a typical inter-graphene spacing of approximately 0.335 nm or slightly larger.

In certain embodiments, the method may further include a step of coating or encapsulating one or a plurality of composite particles of porous carbon host/anode with a thin layer of ion-conducting and/or electron-conducting polymer. The method of encapsulating solid particles by a polymer is well known in the art; e.g., via spray drying, pan-coating method, air-suspension coating method, centrifugal extrusion, vibrational nozzle method, coacervation-phase separation, interfacial polycondensation and interfacial cross-linking, In-situ polymerization, and matrix polymerization.

### EXAMPLE 1: PREPARATION OF POROUS COMPOSITE STRUCTURES INCLUDING SIO_{X} PARTICLES AND A CARBON FOAM HOST FROM PITCH

Pitch powder (granules) were mixed with SiOₓ particles (an anode material) and the mixtures (weight fraction of SiOₓ particles=45%, 70%, and 95%) were placed in an aluminum mold with the desired final shape of the foam. Meso-phase pitch was evacuated to less than 1 torr and then heated to a temperature approximately 300° C. At this point, the vacuum was released to a nitrogen blanket and then a pressure of up to 1,000 psi was applied. The temperature of the system was then raised to 800° C. This was performed at a rate of 2 degree C./min. The temperature was held for at least 15 minutes to achieve a soak and then the furnace power was turned off and cooled to room temperature at a rate of approximately 1.5 degree C./min with release of pressure at a rate of approximately 2 psi/min. Final foam temperatures were 630° C. and 800° C. During the cooling cycle, pressure is released gradually to atmospheric conditions. The foam was then heat treated to 1050° C. (carbonized) under a nitrogen blanket.

### EXAMPLES 2: PREPARATION OF CARBON FOAMS (CFS), AS A POROUS CARBON STRUCTURE HOST FOR SI AND SIO_{X} PARTICLES, FROM POLYURETHANE (PU) FOAM

The production process of polyurethane foam can be divided into the polymer system preparation and the foam production process. Si and SiOₓ particles may be added during the polymer preparation or just before the foam production process. In this study, both uncoated particles and particles pre-coated with phenolic resins were used.

The polymer system preparation involves blending and mixing the components through a mixing head or in a master batching system. The main reactive components are polyols, diisocyanates, and chemical blowing agents. Polyols and diisocyanates are the components for the polymerization process, while diisocyanates and chemical blowing agents (water) are for the gas generation process. Different types of polymer system preparation differ in the method of combining these components. After the polymer system is prepared, its foaming or rise is controlled through different foaming technologies. This can be slabstock, molded, laminated, or sprayed.

As examples, the PU foams were obtained by a one-step method from a two-component system including a polyol mixture and a diisocyanate. The molar ratio of the-NCO isocyanate groups to the hydroxyl groups —OH was 0.8 (for each foam). The polyol mixture included a polyol, a chemical blowing agent which was distilled water, an amine catalyst, Dabco 33-LV (Sigma-Aldrich), and a surfactant, Niax Silicone L-3416 (Momentive Performance Materials). The surfactant was added in amounts of 0.5, 1.0, and 2.0 wt % of the polyol mass. All of the above-mentioned ingredients were added in appropriate amounts and then mixed. A successively weighed amount of PMDI diisocyanate was added to the polyol mixture, and the mixture was mixed again for a few seconds. After mixing, the mixtures were poured into a closed mold and foamed. Then, the foams were removed from the mold and left for 24 h for maturing. Additionally, some of the formulations were synthesized in open forms.

In some formulations, graphene sheets (Angstron Materials, Inc., Dayton, Ohio) were mixed into polyol to serve as a reinforcement for the resulting PU foam and subsequently produced carbon foam samples.

The carbon foams (CFs) were prepared using the PU foam structures produced. The produced PU foams containing anode particles in the pores were first pyrolyzed in N₂ at 900° C. (heating rate: 10° C./min) for 60 min followed by activation in CO₂ (flowrate: 200 mL/min) at 1,000° C. (heating rate—10° C./min) for 100 min.

### EXAMPLE 3: GRAPHENE FOAMS (AS A POROUS CARBON STRUCTURE HOST) FROM HYDROTHERMALLY REDUCED GRAPHENE OXIDE AND SN AND SNO₂ PARTICLES AS THE ANODE ACTIVE MATERIALS

A self-assembled graphene hydrogel (SGH) sample was prepared by a one-step hydrothermal method. In a typical procedure, the SGH was prepared by heating 2 mg/mL of homogeneous graphene oxide (GO) aqueous dispersion (containing 35-85 weight % of Sn or SnO₂ particles) sealed in a Teflon-lined autoclave at 180° C. for 12 h. The SGH containing about 2.6% (by weight) graphene sheets and 97.4% water has an electrical conductivity of approximately 5×10⁻³ S/cm. Upon drying and heat treating at 700° C., the resulting graphene foam exhibits an electrical conductivity of approximately 1.1×10⁻¹ S/cm.

### EXAMPLE 4: PLASTIC BEAD TEMPLATE-ASSISTED FORMATION OF REDUCED GRAPHENE OXIDE (GO) FOAMS (AS A POROUS CARBON STRUCTURE HOST)

A hard template-directed ordered assembly for a macro-porous bubbled graphene film (MGF), containing SiOₓ particles, was prepared. Mono-disperse poly methyl methacrylate (PMMA) latex spheres were used as the hard templates. The GO/water suspension (supplied from Angstron Materials, Inc., Dayton, Ohio) was mixed with a suspension of PMMA spheres and SiOₓ particles. Subsequent vacuum filtration was conducted to prepare the assembly of PMMA spheres, SiOₓ particles, and GO sheets, with GO sheets wrapped around the PMMA beads and SiOₓ particles. A composite film was peeled off from the filter, air dried and calcinated at 800° C. to remove the PMMA template and thermally reduce GO into RGO (reduced graphene oxide) simultaneously. The grey free-standing PMMA/GO/SiOₓ particles film turned black after calcination, while the graphene film remained porous.

### EXAMPLE 5: PRODUCTION OF GRAPHENE BALLS (POROUS GRAPHENE PARTICLES AS A POROUS CARBON STRUCTURE HOST) FROM FLAKE GRAPHITE VIA POLYVINYL PYRROLIDONE-COATED SI PARTICLE-BASED SOLID CARRIER

In an experiment, 5 weight % of Polyvinyl pyrrolidone (PVP) was dissolved in distilled water to form a polymer solution. Si particle were then dispersed into this polymer solution to form a slurry, which was spray-dried to produce PVP-coated Si particles. The PVP-coated Si particles (approximately 200 grams), 50 grams of flake graphite, 50 mesh (average particle size 0.18 mm; Asbury Carbons, Asbury NJ) and 250 grams of magnetic steel balls were placed in a high-energy ball mill container. The ball mill was operated at 300 rpm for 2 hours. The container lid was removed and stainless steel balls were removed via a magnet. The PVP-coated Si particles were was found to be coated with a dark graphene layer. The powder was placed over a 50 mesh sieve and a small amount of unprocessed flake graphite was removed.

A sample of the coated Si particles was then cast over a glass slide and placed in a heating chamber, wherein the graphene-coated PVP/Si particles were heat-treated at 350° C. and then at 600° C. for 2 hours to produce porous graphene/carbon balls containing Si particles dispersed therein.

### EXAMPLE 6: PREPARATION OF POROUS CARBON HOST STRUCTURE FROM PE/NYLON POLYMER NONWOVEN STRUCTURES

The production of nonwoven fabrics typically involves two major processes: web formation and web consolidation. The main web formation methods are carding, air laying, wet laying, spun-bonding, melt-blowing and more recently electro-spinning.

Samples of a polyethylene/nylon 6,6 spunbonded fabric were prepared as described below. Solid pellets of polyethylene was added to a line producing nylon 6,6 fabric. Linear low density polyethylene was be used in the process. In one example, approximately 0.5% linear low density polyethylene was added to nylon 6,6 polymer to produce fabric at 1 ounce per square yard basis weight. The mixture was melted and extruded at a temperature of about 300° C. The melt was spunbonded into continuous filaments and deposited onto a forming wire. The resulting web was then directed to a chemical bonding station where the web filaments were bonded using HCl gas and water vapor at a temperature of about 39° C. The fabric was produced by chemically bonding filaments together in a gas house. The web was then subjected to a roll treatment in which the web was compacted and further bonded. The surface of a layer of nonwoven was coated with a layer of SiOₓ particles, which was then covered by a layer of nonwoven. This was then coated with another layer of SiOₓ particles, which was then covered by another layer of nonwoven. These alternating layers of nonwoven and anode material particles can be stacked to any desired number of layers, with the very top and very bottom layers being of nonwoven.

The multiple-layer structure was then subjected to a polymer carbonization treatment at 300° C. and then raised to and maintained at 1,000° C. for 2 hours in an inert environment to obtain a layer of porous composite including SiOₓ particles.

### EXAMPLE 7: PREPARATION OF POROUS CARBON HOST STRUCTURE FROM NYLON NONWOVEN STRUCTURES

Samples of a nylon 6/nylon 6,6 spunbonded fabric were prepared as described below. Solid pellets of nylon 6 were added to a line producing fabrics. Sufficient nylon 6 was added to the line such that a spunbonded fabric included about 1.6 weight percent nylon 6 with the remainder including nylon 6,6. The mixture was melted and extruded at a temperature of about 300° C. The melt was spunbonded into continuous filaments and deposited onto a forming wire. The resulting web was then directed to a chemical bonding station where the web filaments were bonded using HCl gas and water vapor at a temperature of about 35° C. The web was then subjected to a roll treatment in which the web was compacted and further bonded. The degree of filament bonding was determined by the Taber abrasion method, disclosed in U.S. Pat. No. 3,853,659 to Rhodes, incorporated herein by reference. Layers of porous composite structures were prepared in a similar manner as described in Example 6 above, but the anode active material particles were phenolic resin-coated Si nano particles.

1. A porous carbon/anode material composite, comprising:
(a) a porous carbon structure host having pores and pore walls; and
(b) a plurality of anode active material particles that are disposed in said pores or bonded to said pore walls, wherein a weight fraction of the anode active material particles in the composite is from 0.1% to 99%.

2. The porous composite of claim 1, further including a carbon coating deposited on a surface of said anode active material particles or a carbon matrix with said anode active material particles dispersed in said carbon matrix, wherein the carbon coating or matrix occupies from 0% to 80% by weight of the composite.

3. The porous composite of claim 1, wherein said anode active material is selected from the group consisting of: (a) silicon (Si), germanium (Ge), tin (Sn), lead (Pb), antimony (Sb), phosphorus (P), bismuth (Bi), zinc (Zn), aluminum (Al), titanium (Ti), nickel (Ni), cobalt (Co), and cadmium (Cd); (b) alloys or intermetallic compounds of Si, Ge, Sn, Pb, Sb, Bi, Zn, Al, Ti, Ni, Co, or Cd with other elements; (c) oxides, carbides, nitrides, sulfides, phosphides, selenides, and tellurides of Si, Ge, Sn, Pb, Sb, Bi, Zn, Al, Ti, Fe, Ni, Co, V, or Cd, and their mixtures, composites, or lithium-containing composites; (d) salts and hydroxides of Sn; (e) lithium titanate, lithium manganate, lithium aluminate, lithium titanium niobium oxide, lithium-containing titanium oxide, lithium transition metal oxide, ZnCo₂O₄; (f) carbon or graphite particles; (g) prelithiated versions thereof; and (h) combinations thereof.

4. The porous composite of claim 1, wherein said composite is in a particulate form having a particle size from 50 nm to 50 μm.

5. The porous composite of claim 1, wherein the pores have a pore size from 5 nm to 10 μm and the porous carbon structure host has a porosity level from 0.5% to 99% prior to hosting said anode active material particles.

6. The porous composite of claim 1, wherein one or a plurality of anode active material particles, having a total volume Va, resides in a pore having a pore volume Vp and the Vp/Va ratio is from 1.2 to 5.0, preferably from 1.5 to 4.0.

7. The porous composite of claim 1, wherein the anode active material particles are deposited with a carbon coating or dispersed in a carbon matrix and the particles are bonded to the pore walls through said carbon coating or carbon matrix.

8. The porous composite of claim 1, wherein the pores are interconnected and the porous carbon structure host has a porosity level from 50% to 90%.

9. The porous composite of claim 1, wherein the porous carbon structure host includes a material selected from carbon foam, graphite foam, graphene foam, carbon aerogel, graphite aerogel, graphene aerogel, activated carbon, porous soft carbon, porous hard carbon, porous graphite particle, porous graphene particle or graphene ball, porous meso-carbon micro-bead (MCMB), porous coke particle, a porous structure of pyrolyzed polymer or polymeric carbon, or a combination thereof.

10. The porous composite of claim 1, wherein the porous carbon structure host includes a material selected from carbon foam or carbon aerogel, wherein the carbon foam or carbon aerogel is reinforced with graphene sheets, carbon nanotubes, carbon or graphite fibers, ceramic fibers, glass fibers, polymer fibers, or a combination thereof.

11. The porous composite of claim 1, wherein the composite is in a particle form and the composite particle is further encapsulated by or coated with a layer of carbon, graphene, an ion-conducting polymer having a lithium ion conductivity no less than 10⁻⁶ S/cm, an electron-conducting polymer having an electric conductivity no less than 10⁻⁶ S/cm, or a combination thereof.

12. The porous composite of claim 11, wherein said ion-conducting polymer is selected from poly(ethylene oxide), polypropylene oxide, polyoxymethylene, polyvinylene carbonate, polypropylene carbonate, poly(ethylene glycol), poly(acrylonitrile), poly(methyl methacrylate), poly(vinylidene fluoride), poly bis-methoxy ethoxyethoxide-phosphazenex, polyvinyl chloride, polydimethylsiloxane, poly(vinylidene fluoride)-hexafluoropropylene, cyanoethyl poly(vinyl alcohol), a pentaerythritol tetraacrylate-based polymer, an aliphatic polycarbonate, a single Li-ion conducting solid polymer with a carboxylate anion, a sulfonylimide anion, or sulfonate anion, poly(ethylene glycol)diacrylate, poly(ethylene glycol)methyl ether acrylate, polyurethane, polyurethan-urea, polyacrylamide, a polyionic liquid, polymerized 1,3-dioxolane, polyepoxide ether, polysiloxane, poly(acrylonitrile-butadiene), polynorbornene, poly(hydroxyl styrene), poly(ether ether ketone), polypeptoid, poly(ethylene-maleic anhydride), polycaprolactone, poly(trimethylene carbonate), a copolymer thereof, a sulfonated derivative thereof, or a combination thereof.

13. The porous composite of claim 11, wherein said electron-conducting polymer includes a conjugated polymer selected from polyacetylene, polythiophene, poly(3-alkylthiophenes), polypyrrole, polyaniline, poly(isothianaphthene), poly(3,4-ethylenedioxythiophene), alkoxy-substituted poly(p-phenylene vinylene), poly(2,5-bis(cholestanoxy)phenylene vinylene), poly(p-phenylene vinylene), poly(2,5-dialkoxy)paraphenylene vinylene, poly[(1,4-phenylene-1,2-diphenylvinylene)], poly(3′,7′-dimethyloctyloxy phenylene vinylene), polyparaphenylene, polyparaphenylene, polyparaphenylene sulphide, polyheptadiyne, poly(3-hexylthiophene), poly(3-octylthiophene), poly(3-cyclohexylthiophene), poly(3-methyl-4-cyclohexylthiophene), poly(2,5-dialkoxy-1,4-phenyleneethynylene), poly(2-decyloxy-1,4-phenylene), poly(9,9-dioctylfluorene), polyquinoline, a derivative thereof, a copolymer thereof, a sulfonated version thereof, or a combination thereof.

14. An anode for a lithium battery, wherein said anode includes the porous composite of claim 1 as an anode material.

15. The anode of claim 14, further including a binder and a conductive additive.

16. The anode of claim 14, further including a binder.

17. The anode of claim 14, further including a conductive additive.

18. A lithium battery, wherein said lithium battery includes an anode of claim 17, a cathode, a separator between the anode and the cathode, and an electrolyte in ionic contact with the anode and the cathode.

19. A method of producing porous carbon/anode material composite of claim 1, said method comprising:
A) Preparing a porous polymer structure comprising particles of an anode active material dispersed therein;
B) thermally converting said polymer structure to a carbon structure host having pores and pore walls to host or support said anode active material particles to form a porous carbon/anode material composite structure; and
C) mechanically breaking said porous composite structure into a plurality of porous carbon/anode material composite particles having a dimension from 50 nm to 50 μm.

20. (canceled)

21. (canceled)

22. A method of producing porous carbon/anode material composite of claim 1, said method comprising:
(a) preparing a porous carbon structure including particles of an anode active material dispersed therein, wherein (i) the porous carbon structure host includes a material selected from carbon foam, graphite foam, graphene foam, carbon aerogel, graphite aerogel, graphene aerogel, activated carbon, porous soft carbon, porous hard carbon, porous graphite particle, porous graphene particle or graphene ball, porous meso-carbon micro-bead (MCMB), porous coke particle, a porous structure of pyrolyzed polymer or polymeric carbon, or a combination thereof, and (ii) the anode material particles are coated with a carbon precursor or dispersed in a carbon precursor matrix; and
(b) thermally converting said carbon precursor into carbon, wherein the carbon converted from the carbon precursor and the porous carbon structure prepared in step (a) are merged into a contiguous or continuous carbon phase, enabling the anode material particles to strongly bond to the carbon phase.

23-28. (canceled)

29. A method of producing porous carbon/anode material composite of claim 1, where said method includes a procedure of dispersing a plurality of particles of an anode active material into pores of a porous polymer fiber nonwoven or polymer foam structure and thermally converting the porous polymer fiber nonwoven or polymer foam into a porous carbon structure.
